(19) United States
(12) Patent Application Publication
(10) Pub. No.: US 2003/0046154 A1
(43) Pub. Date: Mar. 6, 2003

(54) Coupon marketing system

(76) Inventors: Blaine Larson, Summit, SD (US); Juan Lopez, Prairieville, LA (US)

Correspondence Address: FRANK A. LUKASIK, # 142, 1250 WEST MARION AVENUE, PUNTA GORDA, FL, 33950, US

(21) Appl. No.: 09/940,834

(22) Filed: Aug. 29, 2001

(51) Int. Cl. G06F 17/60

(52) U.S. Cl. 705/14

(57) ABSTRACT

The present invention resides in apparatus, and software, and a related method for a marketing system which connects advertisers, manufacturers, retailers and customers through coupon incentives and game prizes. A shopping cart return monitoring system issues electronic coupon cards through which customers can purchase discounted items and win prizes and through which manufacturers can attract new customers and sales. System operators are paid by advertisers in return for access to the system and the customers.

### CROSS-REFERENCE TO RELATED APPLICATION

This application is an improvement patent to my previously issued patent U.S. Pat. No. 5,708,782 issued Jan. 13,^{th} 1998.

### BACKGROUND OF THE INVENTION

1. Field of the Invention

The present invention relates generally to a marketing system and more particularly, to systems based upon the distribution and redemption of discount coupons and methods to attract customer participation in merchandise reward programs.

2. Description of the Prior Art

In my prior art patent referenced herein, I disclose a method and apparatus for distributing Discount Coupons to shoppers through the use of shopping cart kiosks. The present invention improves upon that system through the use of computer technology now extant which was previously in its infancy at the time of my prior art patent application. In that referenced patent I disclose;

“Many stores, especially grocery stores, have a plurality of shopping carts which are used to carry goods purchased from the store by the customers to the customer's vehicles. After the goods or groceries are unloaded from the carts, the customer typically leaves the shopping cart in the parking lot area. One problem created by shoppers who simply leave the shopping carts in the middle of the parking lot is that the store must hire personnel to periodically retrieve its shopping carts from the parking lot and return them to the desired shopping cart area. This results in high labor costs for the store. Another problem that stores and their suppliers have is the issuance and use of the familiar “cents off” coupon issued by a manufacturer or “in store” coupons issued by the merchants in order to induce a consumer to purchase that manufacturer's product as opposed to a similar product of another Currently, new technology has made possible the introduction of coupons generated electronically at the point of sales/scan and at the point of buyer's decision, within the aisles of the supermarket. In spite of the success of direct mail delivery and other methods, 98% of the distributed coupons are never redeemed. Over 310 Billion coupons are distributed each year. With a redemption rate of only 2%, the resulting waste of paper which eventually winds up in landfills is between one and two million tons of paper waste. This paper waste results in a negative impact on the environment by increasing the amount of waste deposited in the landfills and the destruction of an equivalent amount of trees consumed in the paper making process plus the energy required to manufacture the paper and print the coupons.”

“There have been a number of proposals to solve one or two of the above problems. U.S. Pat. No. 5,119,087 to Lucas discloses a system for retrieving shopping carts at a store having a plurality of shopping carts. The system includes a counter which can be preset to a first determined count. A target is mounted to each shopping cart while a sensor detects the return of each shopping cart to a designated area. As each shopping cart is returned to the designated area, the sensor generates an output pulse which changes the count in the counter. Whenever the count in the counter achieves a second predetermined count, an alarm is activated that a prize is awarded to the person returning the shopping cart to a designated area. The patent to Lucas is one attempt at solving the problem of turning in shopping carts.”

“U.S. Pat. No. 4,723,212 to Mindrum et al discloses an apparatus and method for creating a discount coupon in response to the purchase of a product other than the one to which the coupon applies. A record pertaining to each item purchased is examined to determine whether the item is intended to trigger the creation of a coupon. If it is, at least one associated coupon deal record is retrieved, and a coupon becomes a candidate for printing, subject to a maximum number of coupons per transaction. The apparatus also validates coupons presented for redemption, scanning a list of purchased products to determine whether any falls into the same product group specified on the coupon, and also determining whether the coupon date is valid.”

“U.S. Pat. No. 4,882,675 to Nichtberger et al discloses a paperless system for distributing, redeeming and clearing merchandise coupons. An electronic display of coupons valid for use in a particular store is presented to customers in that store. When a customer makes a selection of coupons from the display, the selection is recorded. The customer is subsequently identified at a store checkout station as the one who made the selection. In a preferred embodiment, the identification is made by scanning a special card adapted for use with the system. The items purchased in the store by the customer are recorded, and any matches between the coupons selected and the items purchased are determined electronically. The customer is immediately credited in accordance with the terms of the matched coupons. Redeemed coupons are periodically cleared electronically.”

“U.S. Pat. No. 4,908,761 to Tai discloses a system for identifying heavy product purchasers who regularly use manufacturers' purchase incentives and predicting consumer promotional behavior response patterns. The delivery of the coupons to the selected consumer households would also include at least one and preferably a plurality of consumer activated encoding devices each of which is designed to be attached to a coupon. The encoding device delivered to each consumer includes the name and address of the receiving consumer in machine readable language. Those coupons having the attached encoding devices are received for redemption like other coupons, however, the names and addresses of the consumers submitting the encoded coupons received for redemption are read and recorded and a refined list of consumer names and addresses that actually redeem cents-off coupons is created from the initial prepared list of consumers. The consumer list can then be refined and consumer response can be determined.”

“U.S. Pat. No. 4,973,952 to Malec et al discloses a shopping cart display system which includes a cart mounted display that is responsive to trigger signals provided by transmitters associated with a particular location. When the display receives a unique trigger signal, it displays advertising media associated with that location. In one embodiment, the display includes a sensor for determining whether the information is displayed in the presence of a consumer, and a memory for storing all trigger signals received during a given shopping trip. The stored data is transmitted to a polling transceiver located at a point of sale register for later analysis.”

“U.S. Pat. No. 4,937,586 to Stevens et al discloses a low power broadcast system that is used in the so-called “electronic shelf” for retail stores, where the shelf edge carries price displaying modules that can be addressed and controlled from a central computer operated station. The system also permits the modules to broadcast back to the central station to confirm safe receipt of data and to give information as to stock levels, etc. A broadcast system avoids the need for wiring so that location changes are facilitated.”

“U.S. Pat. No. 4,636,950 to Caswell et al discloses an inventory management system using transponders associated with specific products. The transponders can communicate with computer controllers and automated data processing over standard telephone lines by using typical telemetry or other communications systems.”

“Ideally, what is needed from a marketing standpoint is some method of putting a discount coupon for a selected product in the hands of a customer who uses some competing product, to build brand loyalty, to introduce a new product, or to introduce other products in the same line. In addition, a method of encouraging customers to return shopping carts to the proper storage area is also needed. The present invention satisfies this need and as an associated extra benefit works to ameliorate a vexing problem facing retail outlets requiring the use of shopping carts and reduces the amount of paper waste.”

### SUMMARY OF THE INVENTION

The present invention resides in a marketing system using apparatus, and software, and a related method for selecting and electronically storing and distributing a redeemable discount coupon and other offerings in response to the return of a shopping cart to a corral. Briefly, and in general terms, the system of the invention is based upon premiums being offered to customers by manufacturers, retailers and other merchandisers whereby customer patronization of those manufacturers, retailers etc., improves a given customer's odds of winning valuable premiums.

It is therefore a key object of the present invention to attract consumer participation in what amounts to a game in which the consumer participates to;

1. Receive an immediate product discount or free sample.

2. Become eligible to win a major prize.

It is a further object of the invention to attract manufacturer, retailer, or other merchant participation in the same game by offering valuable prizes and discounted prices as rewards to;

1. Gain access to, and the attention of, those consumers participating in the game.

2. Direct their marketing to specific demographics or geographic areas.

3. Be able to move merchandize localized in limited areas without the need to broadly advertise that which is not generally available.

It is a further object of the present invention to provide a system and methodology for economically retrieving shopping carts and distributing coupons.

It is a further object of the present invention to provide a system and methodology which issues and tracks the redemption of coupons while providing an incentive for shoppers to return their carts.

The above objects, as well as others which will hereinafter become apparent, are accomplished in accordance with the present invention by providing a system and methodology which initially involves a Computer Command Center database (CCC), communicating through a computer network, with a store database to shopping cart corrals located in a shopping center parking lot. Each corral contains a computer screen which may display a series of promotion coupons. A customer, upon returning a cart, or otherwise having access to the screen, may select the desired coupon from the screen and a coupon is transferred electronically to the account ID used. In addition, a consumer having a validated key will have access to other electronic coupon dispensing terminals located in the area.

### IN OPERATION

From a consumer point of view, the present invention system (SYSTEM) appears as follows; Consumer drives car to the local Supermarket, walks to a nearby Quonset hut and retrieves a shopping cart. The carts are neatly aligned in rows ready for use. A SYSTEM coupon dispensing machine is positioned above each row of carts. The dispensing machine displays on a “Touch” screen display, multiple manufacturer coupons. When the consumer touches the screen over a particular product display, the SYSTEM dispenses a SHOPPERS CARD KEY (SHOPPERS CARD KEY ) and simultaneously releases the shopping cart. (Prior to dispensing the card, the SYSTEM encodes upon the card a coupon for the selected product i.e. a free box of cereal, a PREMIUM (PREMIUM))

Consumer proceeds to shop using the cart and carrying the SHOPPERS CARD KEY. Consumer completes shopping, checks out and hands the SHOPPERS CARD KEY to the clerk. The clerk scans the card, the price of the free box of cereal is subtracted from the receipt total and SHOPPER'S MILEAGE POINTS (SHOPPER'S MILEAGE POINTS) are encoded on the SHOPPERS CARD KEY. The consumer pays the corrected total and the clerk returns the SHOPPERS CARD KEY and the receipt. Consumer returns to car and unloads the cart, then returns the empty cart to the Quonset wherein she is instructed to insert the SHOPPERS CARD KEY into the SYSTEM. While the SHOPPERS CARD KEY remains in the machine, consumer is invited to choose from a selection of bonus coupons displayed on the monitor screen. At this time, consumer becomes eligible to win instant cash which is periodically distributed along with the coupons. Consumer now selects another coupon i.e. for a bottle of Ketchup at half price and upon touching the screen by the Ketchup offer, is rewarded, not with a Ketchup coupon as expected, but with ten dollars credited to her SHOPPERS CARD KEY. This credit is redeemable for cash within the store at consumer's convenience.

At this point, consumer has saved four dollars and sixty eight cents by selecting and redeeming the cereal coupon and has ten dollars cash credit built into the SHOPPERS CARD KEY. Consumer's SHOPPERS CARD KEY is honored at all participating stores as long as the SHOPPERS CARD KEY is used and the coupons redeemed.

Consumer on a further occasion enters another store, this time a store having a free standing coupon dispensing machine inside the store. Consumer places the SHOPPERS CARD KEY into the machine and selects another product coupon, consumer must redeem that coupon before being able to select another. As long as consumer continues this process of selection and redemption of coupons, SHOPPER MILEAGE POINTS continue to accumulate on the SHOPPERS CARD KEY. Once a predetermined number of SHOPPER MILEAGE POINTS have accumulated on the SHOPPERS CARD KEY, the consumer becomes eligible to try to win a GRAND MEGA PRIZE by inserting the SHOPPERS CARD KEY into the SYSTEM machine and choosing from a special screen display of valuable prizes.

In the entrance of stores that are shopping cart sites will be card readers which will be connected to the wide area network and to a printer similar to a cash register receipt printer which will allow the customer to swipe their card and get a print out of the coupons and any cash rewards they have earned. This printout will allow them to see the products they have coupons for in that store.

In stores that have freestanding units the reader printer will be next to or a part of the freestanding unit and will allow the customer to get the same printout of savings coupons they have on their card.

### Web Application

While at home customers will be able to access a web page which will list all sites in their community that offer this service. From that web page customers will be able to visit any site they wish. Each site will have a list of regular manufacturer coupons (such as those offered in newspaper supplements and free standing inserts) and in store coupons being offered for products available at each individual store site. Customer will enter the ID number for their card and will be able to select coupons they wish to use on their next visit by clicking on the selection. Their selections will be saved internally within the wide area network. On their next visit to that store they will get a list of their selections when they swipe their card at the reader printer. After selecting their purchases all coupons will credited at checkout when the clerk swipes the card through a card reader at the checkout which is connected to both the store and this service's network. Coupons will be electronically redeemed through this same system. For customers that do not have web access in their home there may be a terminal available at the store set up so that they can select their regular value coupons right at the store.

Although cards will be used only as an identification device with all data stored within the wide area network system, the option and ability will exist to collect and store this information on each individual card if necessary.

From a manufacturer's/retailers point of view, the SYSTEM provides several unique marketing opportunities;

1. Large big ticket items such as new automobiles can receive national exposure through a multitude of SYSTEM terminals throughout the country. This exposure makes it cost effective for a manufacturer to offer the automobile as a prize. The SYSTEM can be configured such that the SYSTEM operators can pre-set the number of “hits” a particular prize must receive before a consumer wins it. Accordingly, the SYSTEM operator can contract with the manufacturer to provide a given number of such “hits” before the prize is awarded to the consumer and before the SYSTEM operator is paid an advertising fee by the manufacturer.

2. Local retailers wishing to move a limited or localized inventory can bid for space on local coupon dispensing machines and so target consumers in those areas. The SYSTEM operator in this case, makes available those spaces and sells them at whatever bidding price can be achieved.

This flexibility and scalability is the essence of the SYSTEM of the present invention. The SYSTEM offers the benefits to consumers, and those who wish to sell to them or to attract their attention by producing a revenue stream based upon increased customer participation and the sale of access to the SYSTEM by manufacturers, retailers etc.

The features and advantages of the invention will be further understood upon consideration of the following description of the preferred embodiment taken in conjunction with the drawings.

### BRIEF DESCRIPTION OF THE DRAWINGS

FIG. 1 is a flow chart denoting the program sequences which control the shopping cart and shopper's key card system.

FIG. 2 is a diagram showing the network hardware of the invention..

FIG. 3 is a diagram showing the wide area network of the invention.

FIG. 4 is a flow chart denoting the interaction between the participants in the marketing system of the invention.

### DESCRIPTION OF THE PREFERRED EMBODIMENT

As described in my prior art patent, the method and apparatus for dispensing discount coupons of the invention is a unique new channel for the electronic distribution of manufacturer's merchandise coupons. The system has been designed to facilitate the management of shopping cart related costs experienced primarily but not exclusively, by the supermarket industry. More specifically, the means for the selection of a coupon is provided to the customer of a retailer who uses and returns a shopping cart to the corral provided for its storage. A computerized kiosk is located at the entrance of the corral. During the operating hours of the retail outlet, the kiosk corral is maintained in a standby status with the security doors open and the kiosk in operation. Customers take their shopping carts from the corral, at which time they receive an electronic coupon credited to their database ID account with a coded ID key and proceed to make their purchases.

While the concept of the invention is simple, the necessary infrastructure to properly implement and control a wide-area data distribution and retrieval system in a point-to-multipoint network configuration is quite complex. Two basic needs are provided with the pairing of a cost effective and demographically targeted coupon distribution method for consumer packaged goods manufacturers and effective method of cost containment for retailers in the specific areas of: labor, to retrieve carts; shrinkage, theft and premature obsolescence; and liability, on site and off site. The inventive concept links the two concepts in an effective solution for both: The manufacturers get an alternative cost effective means for the distribution on a targeted basis to the consumer; The lead time required to launch a coupon campaign is much shorter than traditional advertising and enables the manufacturer to counter more rapidly competitor efforts to garner market share.

Another very important feature of the invention is its security. Coupon mis-redemption is a $600-$800 million industry. Elimination of the paper and print and other security measures will eliminate these coupons as an attractive target for counterfeiters.

In addition, the retailer competes more effectively by lowering significant costs in areas that have eluded management efforts for the past fifty years.

By way of improvement to my prior art patent, the superimposition of “game” elements over the infrastructure described herein creates a unique method for attracting both consumers and manufacturers to each other's attention, such being the essence of successful marketing models.

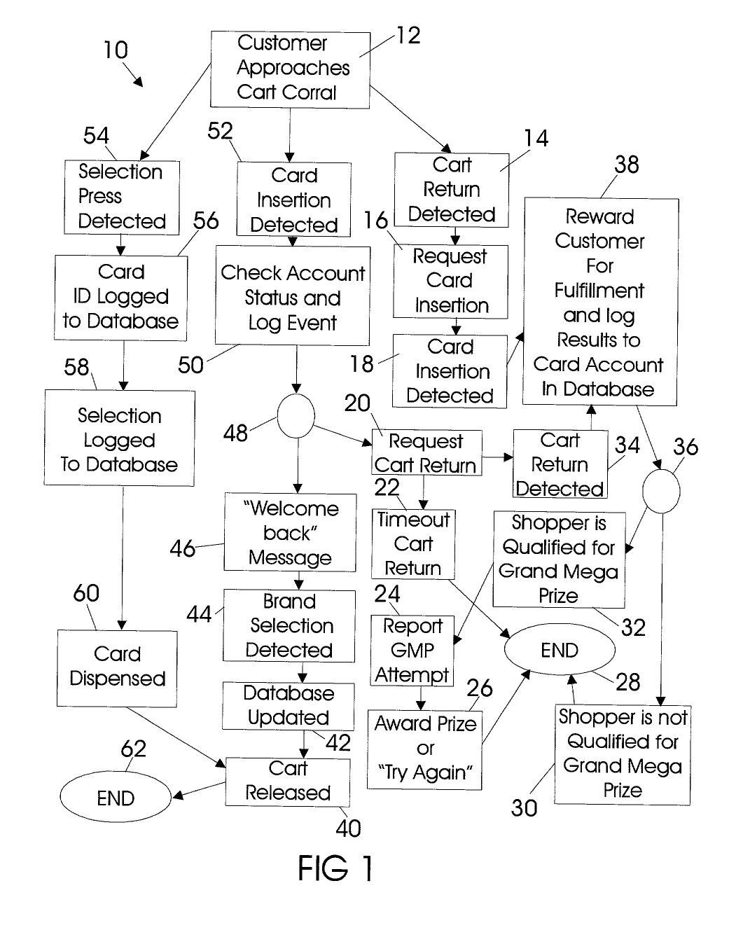

Referring now to the drawings in which the elements of the present invention are illustrated and in particular to FIG. 1, the Shopping Cart Control Center logic flow is designated overall by the numeral 10. A typical sequence of the operation of the system of the invention follows; Customer approaches the cart corral 12, card insertion is detected 52, customer account status is checked and the event is logged 50, option function 48, cart return request 20 is initiated and if the customer is only returning a cart for a reward, cart return is detected 34, customer is rewarded for the fulfillment and the results are logged in the database 38. If the customer does not return the cart and proceeds to shop, the “Welcome back” message is displayed 46, customer's brand selection is detected 44, system database is updated to reflect this choice 42, cart is released 40 and sequence ends 62. In the event of a new customer, the sequence follows; Customer approaches cart corral 12, and selects a coupon, selection key press is detected 54, card ID is logged in the system database 56, selection is logged into the system database, a shopper key card is dispensed 60, cart is released 40 and sequence ends 62.

As customer returns the cart, the following sequence occurs; Customer approaches cart corral 12, system detects the cart return 14, screen displays request for card insertion 16, card insertion is detected 18 and customer is rewarded for fulfillment 38. Option 36—Shopper is qualified for attempt at Grand Mega Prize 32, the attempt is logged 24, a prize is awarded if the Shopper is successful, or a “Try Again” message is displayed if not 26 and the sequence ends 28. Option 36—Shopper is not qualified for an attempt at the Grand Mega Prize, the sequence ends.

If the Customer at option 48 receives the request for cart return 20 and does not return the cart 34, the system records a timeout for the cart return 22 and the sequence ends 28.

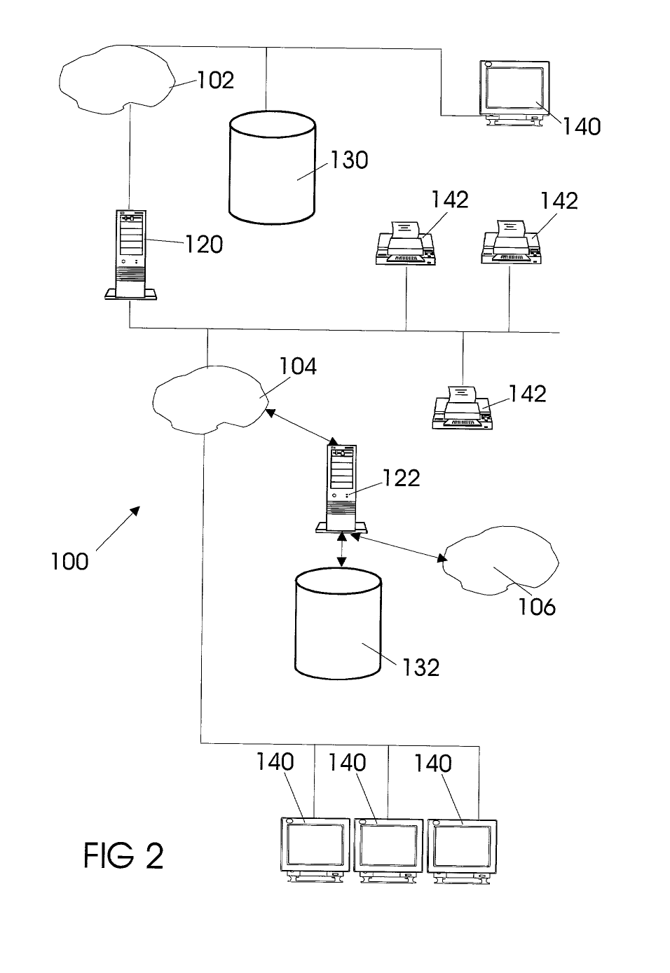

Referring now to FIG. 2 wherein the system network is designated overall by the numeral 100. Store's existing network 102 maintains store's existing inventory files on the Database server 130, point of sale terminals 140 interact with database server 130.

Network 102 interfaces with Coupon Printers 142 through Security Firewall 120. Store area network 104 and terminals 140, interface with in store process server 122 which manages terminals at cart corrals and updates with corporate command and control database servers by connecting through wide area network 106. In-Store database server 132 hosts the coupon system of the invention.

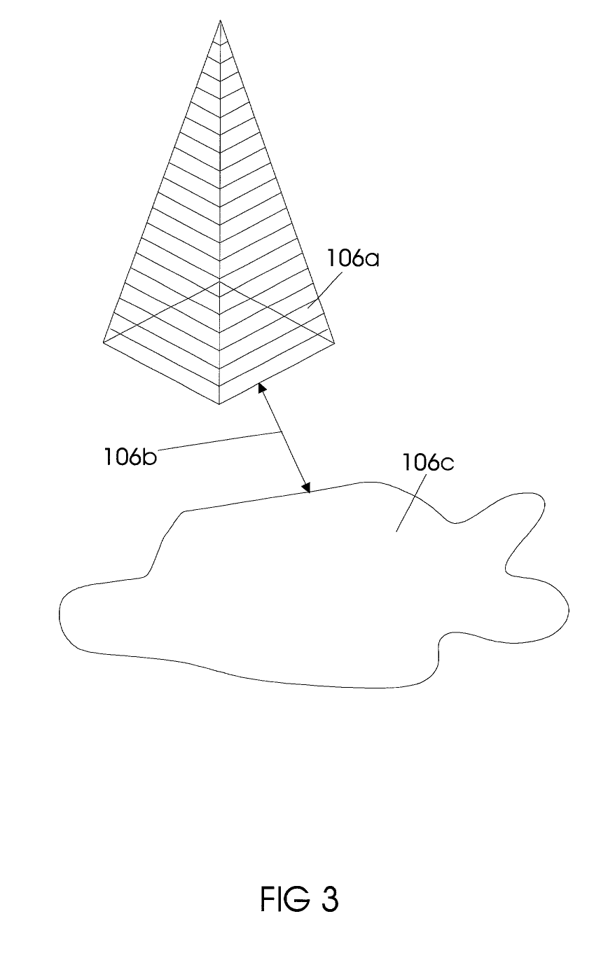

Referring now to FIG. 3, Wide area network 106c connects all involved entities 106a-106b and is constructed with any and all of the available technologies including wired 106b and wireless 106a, internet, private new, terrestrial, satellite and any forthcoming network technology.

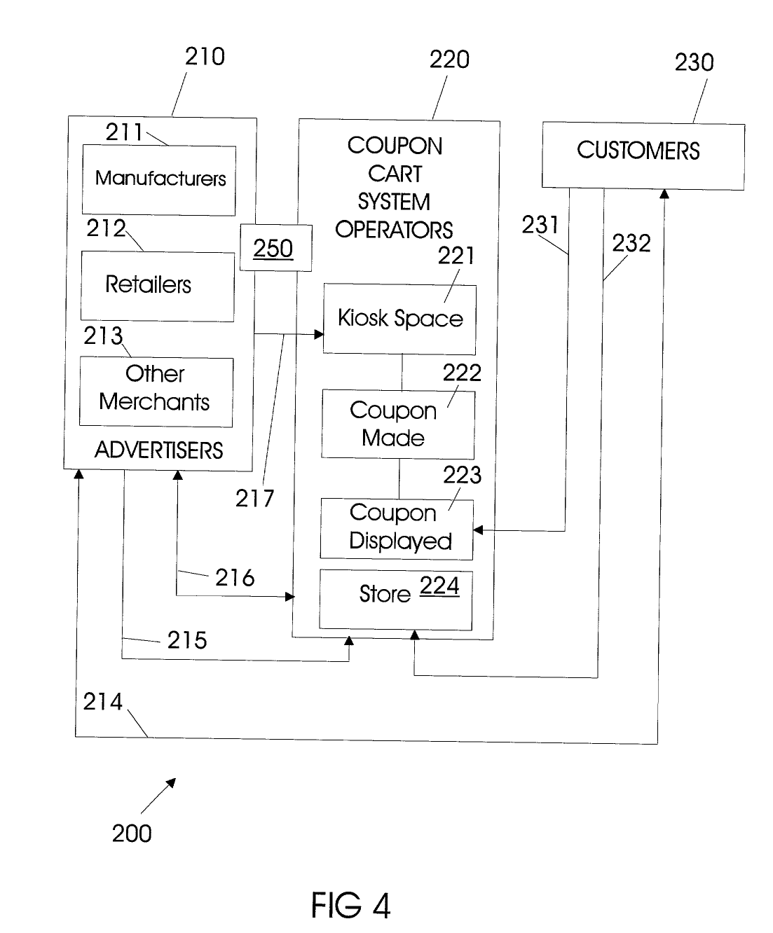

Referring now to FIG. 4 wherein the “Marketing Game System” of the present invention is designated overall by the numeral 200. Manufacturers 210, System operators 220 and customers 230 interact as follows;

System operators 220 contract 250 with Advertisers 210. Operators display available kiosk space 221 and advertisers 210 bid on the space 217. Advertising coupon 222 is made, and displayed 223. Customers 230 view coupon display 231 and visit store 224 to redeem coupon 232. Advertisers and customers are now connected commercially 214. Advertisers continue to offer premiums 215 through System 220. System and advertisers exchange revenue/services 216.

It will be appreciated that, although a specific embodiment of the invention has been described in detail for purposes of illustration, various modifications may be made without departing from the spirit and scope of the invention. Accordingly, the invention is not to be limited except as by the appended claims.

What is claimed is:

1. A system and method of using a computer to create and monitor a discount coupon marketing system for manufacturers and retailers to attract customers to their products by issuing redeemable electronic coupons from shopping cart return kiosks and stand-alone terminals in retail locations, the system comprising:
a wide area network for storing and disseminating a database of manufacturer's coupon information, said data base including computer and software means for collecting, storing, and disseminating individual logo, coupon redemption price, bar code and locations to which said information is transmitted,
a store process server operatively connected to said wide area network for managing terminals at cart corrals and updating corporate command and control database servers,
an in-store data base server operatively connected to said store process server, said in store data base server hosting the coupon system,
a store area network operatively connected to said store process server, a security firewall operatively connected and a security firewall operatively connected to said store area network, and
a store network having a store inventory database server, a plurality of point of sales terminals, and a plurality of coupon list printers available to store customers.

2. The system of claim 1 further comprising:
an encoding means for creating an electronically readable coupon card, and
electronic display means for displaying manufactured products, said display having a touch screen interface access means,

3. A method of using a computer to create and monitor a discount coupon marketing system for manufacturers and retailers to attract customers to their products by issuing redeemable electronic coupons from shopping cart return kiosks and stand-alone terminals in retail locations, said method comprising the steps of:
inputting into the computer updateable database information concerning entities designated as manufacturers, a plurality of manufactured products, and discount information relating to said manufactured products,
storing and disseminating a database of manufacturer's coupon information including individual logos, coupon redemption price, bar code and locations to which said information is transmitted,
communicating said database information to a plurality of retailers,
managing terminals at cart corrals and updating corporate command and control database servers,
encoding an electronically readable coupon card,
displaying manufactured products on a touch screen interface, and
creating electronically readable coupon cards, and issuing said coupon cards selected on said touch screen.
